(19) United States
(12) Patent Application Publication
(10) Pub. No.: US 2015/0136753 A1
(43) Pub. Date: May 21, 2015

(54) ELECTRICALLY-POWERED THERMAL-REGULATED APPAREL AND CONTROL SYSTEM THEREFOR

(71) Applicant: Gerbings, LLC., Stoneville, NC (US)

(72) Inventors: Charles E. Cronn, Fort Lee, VA (US); Cupid Roberts, Stoneville, NC (US); Tony Connor, Greensville, NC (US)

(21) Appl. No.: 14/503,804

(22) Filed: Oct. 1, 2014

Related U.S. Application Data
(60) Provisional application No. 61/885,166, filed on Oct. 1, 2013.

(51) Int. Cl. A41D 13/005; H05B 3/00

(52) U.S. Cl. CPC A41D 13/0051; H05B 3/00
USPC 219/211

(57) ABSTRACT

The present inventive concept relates to electrically-powered, thermal-regulated apparel or heated garments and a controller and related methods of operation thereof. The thermal-regulated apparel item includes a heating assembly having a substrate and shielding layers with an electrical resistance heating element located therebetween. The controller is linked to the heating element and receives measured electrical resistance values from a thermistor or a voltage level of a thermocouple positioned along the heating element and in response, varies an electrical power output to the electrical resistance heating element such that the measured or monitored resistance value of the thermistor, or voltage level of the thermocouple, is maintained relatively constant with respect to a predetermined resistance value or voltage level.

### CROSS-REFERENCE TO RELATED APPLICATIONS

The present Patent Application is a formalization of previously filed, co-pending United

States Provisional Patent Application Serial No. 61/885,166, filed Oct. 1, 2013 by the inventors named in the present Application. This Patent Application claims the benefit of the filing date of this cited Provisional Patent Application according to the statutes and rules governing provisional patent applications, particularly 35 U.S.C. §119(a)(3), 119(a)(4) and 37 C.F.R. §1.78(a)-(c). The specification and drawings of the Provisional Patent Application referenced above are specifically incorporated herein by reference as if set forth in their entirety.

### FIELD OF THE INVENTION

The present disclosure generally relates to heated or thermally-regulated apparel and to a control device, system, and related methods for thermal regulation in garments/apparel, including self-governing thermally regulated apparel and related articles. Specifically, it relates to heated or thermally-regulated garments or apparel and a control system therefor, including a controller capable of detecting electrical resistance values, voltage levels, or similar data sets, and adjusting the thermal output of the garment to predetermined or desired levels that can be established by a user.

### BACKGROUND OF THE INVENTION

In the garment and apparel industry, manufacturers, designers, and engineers have attempted to address the issue of temperature regulation in heated or thermally-regulated apparel. Individuals residing in extreme weather environments may require apparel or garments or other similar articles designed and manufactured to address user comfort and survival in such environments. Likewise, individuals participating in certain work-related or recreational activities may also require apparel and garments designed and manufactured to address comfort and feasibility in engaging in such work or recreation. For example, soldiers and aircraft crew often must perform tasks or operations in extreme cold environments, and thus have a need for protective clothing that provides needed warmth and protection from hypothermia, without restricting movement and which can be expanded and be used in a variety of different environments. Additionally, such protective clothing also can be subjected to and thus must be protected from other potential problems/conditions, such as exposure to electrical surges or interference.

To that end, various manufacturers, designers, and other entities have attempted to address the associated needs of such individuals. Known methods, devices, and systems generally measure ambient temperature of an end user as a reference point, then attempt to maintain or adjust heat production in response to environmental changes based on a previously recorded ambient temperature reading. Disadvantageously, this approach typically can require multiple monitoring points, expensive equipment capable of taking such temperature measurements within a narrow error range, and often a multitude of sensors and/or other components that can potentially lead to or create numerous failure points that can hinder overall function of the heated garment. The need for such additional temperature monitoring devices or components also can add to the overall expense, as well as the weight/bulk of a garment in which they are installed, and can otherwise affect the freedom of movement, fit and comfort of the garment.

Various devices and methods attempting to address the issue of apparel/garment temperature regulation include: U.S. Pat. No. 5,148,002; and U.S. Published Patent Application No. 2007/0199137.

Accordingly, a need exists for heated or thermally regulated garments, apparel or other, similar articles and a control system therefor that addresses the foregoing and other related and unrelated problems and challenges in the art.

### SUMMARY OF THE INVENTION

Briefly described, the present invention generally is directed to a heated garment or thermally regulated apparel item, or similar articles, with integrated shielding for protection against electromagnetic or other electrical interference, and a control device, system, and related methods for self-governing operation/control of such thermally regulated apparel, which can be operated independent of recording, measuring, or otherwise determining an actual temperature value. Thus, no actual temperature value measurements are necessary for operation and achieving the desired self-governing control of the thermally regulated apparel and control system, and related methods of the present inventive concept.

Objects of the present inventive concept include providing an electrically-powered heated or thermally regulated garment or one or more articles of apparel and a controller therefor. In one embodiment, the controller can include at least two user operable and/or settable controls. A first input or user control can be configured to establish an electrical power output from an electrical power source to an electrical power outlet connector. The electrical power output can continuously repeat at a predetermined amperage and also for a predetermined frequency and duration, depending on input from the user.

The controller also can include a second input or user control. The second input or user control is capable of being engaged and disengaged by the user, and can be configured such that when initially engaged, electrical resistance values of a thermistor is measured; or, alternatively, a voltage level of a thermocouple can be measured. As such resistance value(s) and/or voltage level(s) are measured, as long as the second user control is engaged, the first user control can be overridden and the user can adjust the power supplied to correspondingly adjust the heating applied by the garment/apparent item. Once a heating level for a desired comfort level of the user/wearer is determined by the user, a corresponding electrical resistance value or voltage level, or desired ranges thereof, can be selected/set via the second input or user control, i.e., by the user activating the second input control or inputting a selected set point or range therefor.

Thereafter, the electrical power output to the heating element(s) of the garment/apparel item will be controlled/varied in response to feedback from the garment/apparel item such that the electrical resistance value(s) of the thermistor, the voltage levels of the thermocouple, remains relatively constant with respect to the initially set/predetermined resistance or voltage level values. In other words, the resistance value and/or voltage level can be substantially maintained within a predetermined range with respect to the initially determined/measured and set values therefor. When the second input or user control is disengaged or deactivated, the electrical power output can return to a last electrical power output setting established by operation of the first input or user control.

In some embodiments, the controller can include two or more electrical power outlet connectors, each operating independently from the other, two or more first input or user controls, each operating independently from the other, and two or more second input or user controls, which also can each operate independently from the other. In some embodiments, the controller further can include separable parts in wireless communication with each other, sometimes referred to as a transmitter and a receiver, although both components can comprise transceivers capable of both transmitting and receiving wireless signals.

Additional objects of the present inventive concept include providing electrically-powered thermally regulated apparel system, including a controller as discussed above. The system also includes thermally regulated apparel or heated garments that can be connected to an electrical power outlet of the controller, through which electric power will be regulated and supplied to the apparel item from an electrical power source connected to a power input of the controller. In one embodiment, the thermally regulated apparel item or heated garment can include a shirt, jacket, pants, socks or other footwear, gloves, or hat or other head gear, or other, similar article of clothing and/or various combinations or sets thereof. For example, the thermally regulated apparel item can include a shirt or similar garment including a body having first and second or front and back portions, sleeves, and a neck portion or collar. A heating element assembly can be applied to one or both of the front and back portions of the heated shirt, with each heating element assembly generally being configured to provide a desired coverage area across the front and/or back portions of the shirt.

Each heating element assembly further generally will include a substrate or base layer, which can be formed from a flexible fabric material and over which a shielding layer of an electro-magnetic or other electrical interference (EMI) shielding material or fabric will be applied. An electrical resistance heating element, which can comprise a conductive wire, thread, filament or fiber, generally will be applied between the base layer and EMI shielding layer. In one embodiment, the electrical resistance heating element can be applied to the base layer or substrate, such as by stitching or other means, in a desired pattern extending substantially along and across the substrate and with the ends thereof being connected to a plug-in connector. Alternatively, the electrical resistance heating element could be applied or attached to the EMI shielding layer, such as by stitching or sewing the electrical resistance heating element thereto, and then attaching the EMI shielding layer to the base layer or substrate. Additional shielding layers further can be applied thereover as needed.

In addition, one or more thermistors can be imbedded or installed at one or more desired locations along the heating element of each heating element assembly. The thermistor(s) will be linked to the controller for the thermally regulated apparel item via leads or other connections, or each can be connected to a secondary controller or module imbedded within their associated heating element assembly. The thermistor(s) will provide feedback to the controller of measured or monitored electrical resistance of the electrical resistance heating element. In response, the controller will regulate or control the electrical power provided to the electrical resistance heating element of each heating assembly as needed to maintain the monitored resistance within a desired or predetermined range to control the amount of heat applied by each heating assembly to its thermally regulated apparel item. Alternatively, one or more thermocouple(s) can be similarly imbedded within each heating assembly of the thermally regulated apparel item and will provide feedback to the controller as to voltage levels being supplied to each heating assembly.

In some embodiments, the power source for the thermally regulated apparel system or item can be detachably connected to the thermally regulated apparel item independent of the electrical connections, for example, including a battery or power supply incorporated into the apparel item or via connection to an electrical generator of the controller itself. In other embodiments with multiple power outlet connectors, one connector can be attached to one apparel item and another connector connected to a second apparel item, with each different apparel item being regulated independently from the other.

Additional objects of the general inventive concept include providing a method of heating an electrically-powered thermally regulated apparel item. The method includes establishing an electrical power output from an electrical power source to an electrical power outlet connector in the controller as described above. In some embodiments, the method includes measuring the electrical resistance value of a thermistor or measuring a voltage level of a thermocouple and varying the electrical power output such that the resistance value or voltage level remains relatively constant with respect to the initially measured value/voltage level.

When the controller is activated by a user, an initial value or set/range of initial electrical resistance values of a thermistor can be recorded. In other embodiments, an initial voltage level value or set/range of values of a thermocouple can be recorded. The (electrical resistance or voltage level) value typically will be arbitrary and generally will have no direct correlation to an actual ambient temperature until set or correlated by user activation of the controller. Once such a resistance or voltage level is established and set, the controller unit thereafter will apply varying levels of power from the power source, to provide varying levels of thermal output to the self-governing apparel, thereby maintaining the electrical resistance of the thermistor (or voltage level of the thermocouple) within a predefined range with respect to the recorded value to thus maintain heating of the garment in accordance with the preferences of the user.

Often, thermistor based heating control appliances or designs will call for approximately 1% tolerance thermistors to be used. However, since there are numerous different response curves for different thermistors, the thermistor curve type also must be specified and taken into account, which can represent an additional barrier to designing apparel capable of thermal regulation. However, by utilizing a predetermined or arbitrary setpoint that is recorded when the controller unit is activated by a user, the control system on the circuitry thereof can be built using lower quality parts, or parts with a wider tolerance range. For example, instead of using expensive temperature sensors or alternatively more costly 1% precision thermistors, the control system, and related methods can be implemented using significantly lower cost thermistors, for example, approximately 10% tolerance thermistors.

Contrastingly, the present invention also permits any thermistor to be used, and each thermistor used need not be identical to other thermistors. A thermistor with a tolerance of 20% can work as well as a thermistor with a tolerance of 1%. Even the thermistor resistance curve type used does not substantially affect the operation of the present inventive concept. There thus is no need for the circuit designer to maintain or use a known component value; this allows for substantial cost savings, as the difference between a 1% tolerance component versus a 10% tolerance component can be orders of magnitude in difference. The same applies to the use of a thermocouple.

The foregoing and other objects are intended to be illustrative of the general inventive concept and are not meant in a limiting sense. Many possible embodiments of the invention may be made and will be readily evident upon a study of the entire specification and accompanying drawings comprising a part thereof. Various features and subcombinations of the general inventive concept may be employed without reference to other features and subcombinations. Other objects and advantages of the general inventive concept will become apparent from the following description taken in connection with the accompanying drawings, wherein is set forth by way of illustration and example, an embodiment of this invention and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings. For the purpose of illustration, forms of the present general inventive concept which are presently preferred are shown in the drawings; it being understood, however, that the general inventive concept is not limited to the precise arrangements and instrumentalities shown. In the drawings:

FIG. 1 illustrates one exemplary embodiment of a controller for a thermally-regulated apparel item according to the principles of the present invention.

FIG. 2 illustrates another exemplary controller for a thermally-regulated apparel item according to the principles of the present invention with the controller having two parts.

FIG. 3 illustrates another exemplary controller for a thermally-regulated apparel item according to the principles of the present invention with the controller having multiple parts and multiple independent operating channels.

FIGS. 4A-4B illustrate one example embodiment of a thermally-regulated apparel item in accordance with the principles of the present invention.

FIG. 5 illustrates interconnected heating element assemblies of the thermally-regulated apparel item of FIGS. 4A-4B in accordance with the principles of the present invention.

FIGS. 6A-6C illustrate one embodiment of a thermally-regulated apparel item with a shielding layer in accordance with the principles of the present invention.

FIGS. 7A-7D illustrate yet another embodiment of a thermally-regulated apparel item with a shielding layer in accordance with the principles of the present invention.

FIG. 8 illustrates an example of a thermally-regulated apparel system according to the principles of the present invention showing examples of various thermal-regulated apparel items connected in series.

### DETAILED DESCRIPTION

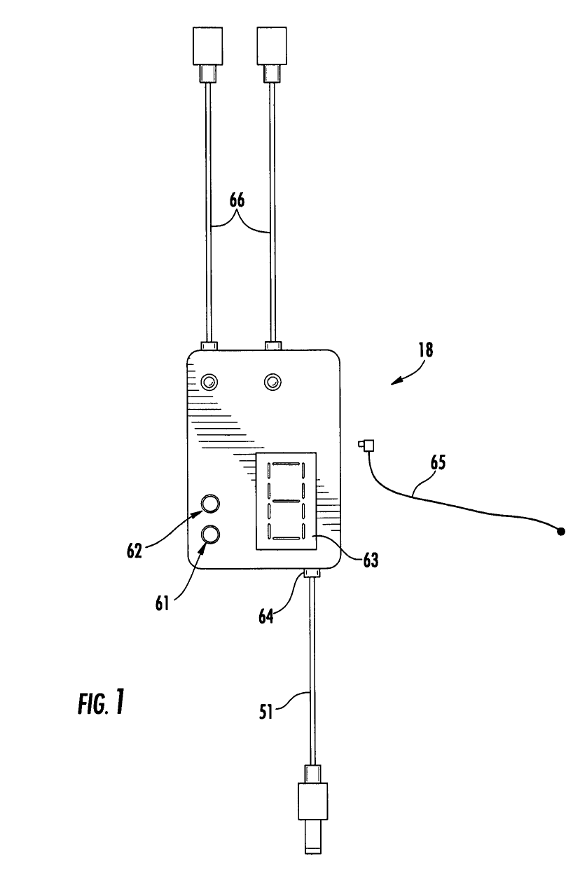

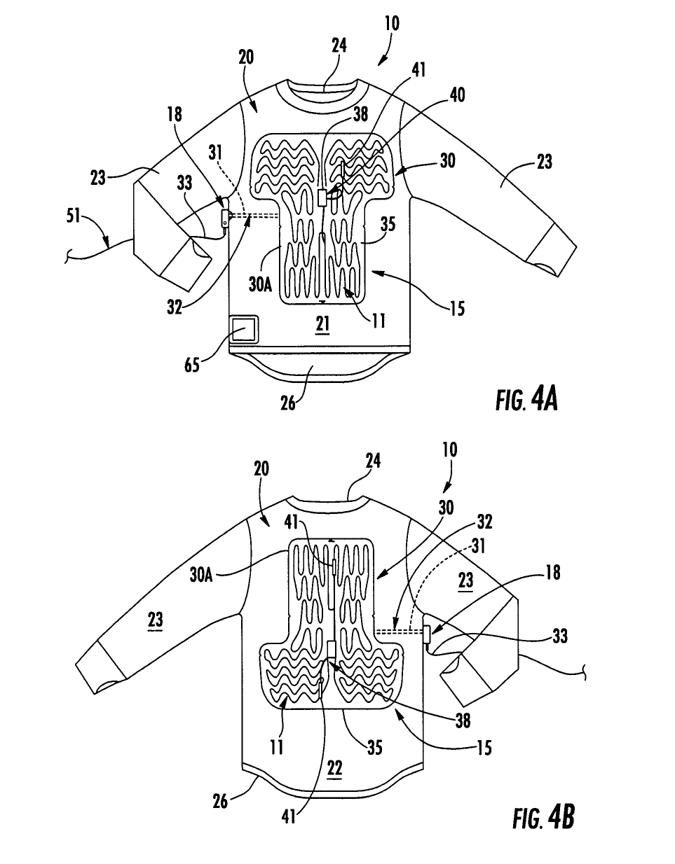

Referring now to the drawings in which like numerals indicate like parts throughout the several views, the present inventive concept shown in FIGS. 1-7B is directed to self-governing thermally regulated or heated apparel/garments 10 (FIGS. 4A-4B) and to a system and related methods of control for such self-governing thermally regulated apparel/garments. In one embodiment, thermal output or heat applied through the apparel/garment item 10 will be controlled through the regulation of the application of electrical power from a power source to an electrically restrictive heating element 11 of one or more integrated heating assemblies 15 integrated into the apparel item or garment. A user, (i.e., the person wearing the apparel item or garment), can engage an apparel controller unit 18 to determine/select or set a desired or acceptable thermal output i.e., corresponding to a desired level of heating or temperature or range of temperatures felt by the wearer or user based upon monitored data sets or values such as a measured electrical resistance value across the heating element by a thermistor imbedded in one or more heating assemblies 15 of the apparel item or garment. Thereafter the apparel controller unit can operate to substantially automatically regulate the thermal output or heat applied by the heating assemblies of the apparel item by monitoring and/or receiving measured feedback values of electrical resistance (i.e., from the thermistors imbedded within such heating assemblies), and accordingly adjusting the power level applied to the heating assemblies if detected electrical resistance values fall outside of the previously recorded or predetermined/set resistance value or range of values.

For example, more or less power can be provided to the heating elements of the heating element assemblies to heat the apparel item decrease the application of heat thereto by increasing or decreasing the electrical resistance until the monitored electrical resistance values were detected as within a desired range or meeting a desired or preset value. Operation of the present system for control of self-governing thermally regulated apparel or heated garments further can be controlled substantially independently of the actual thermal, without requiring monitoring and recording of the actual temperature values at one or more locations along the thermally regulated or heated apparel/garment. Instead, the thermally regulated apparel or garments of the present invention enable the use of lower cost mounting or measuring equipment that further can be installed, imbedded or otherwise applied to the self-thermally regulated or heated apparel/garment without substantially adding to bulk or otherwise adversely affecting the comfort and movement of the user wearing such a garment.

FIGS. 1-3 illustrate embodiments of the apparel control unit 18 for use with self-governing thermally regulated or heated apparel or garments 10 of the present invention, various examples embodiments of which are shown in FIGS. 4A-8. While the Figures illustrate the use of particular apparel items or garments, for example, showing a shirt in the embodiment shown in FIGS. 4A-7D, it will be understood by those skilled in the art that the self-governing thermally regulated apparel or heated garments and control system therefor can be applied to a variety of other types of garments or items of apparel, including, but not limited to, jackets, coats, windbreakers, vests, pants, shorts, leggings, undergarments, socks, hats and other similar items. Such apparel items or garments further can be interconnected and controlled in series or as a connected/whole body apparel system or set as illustrated in FIG. 8.

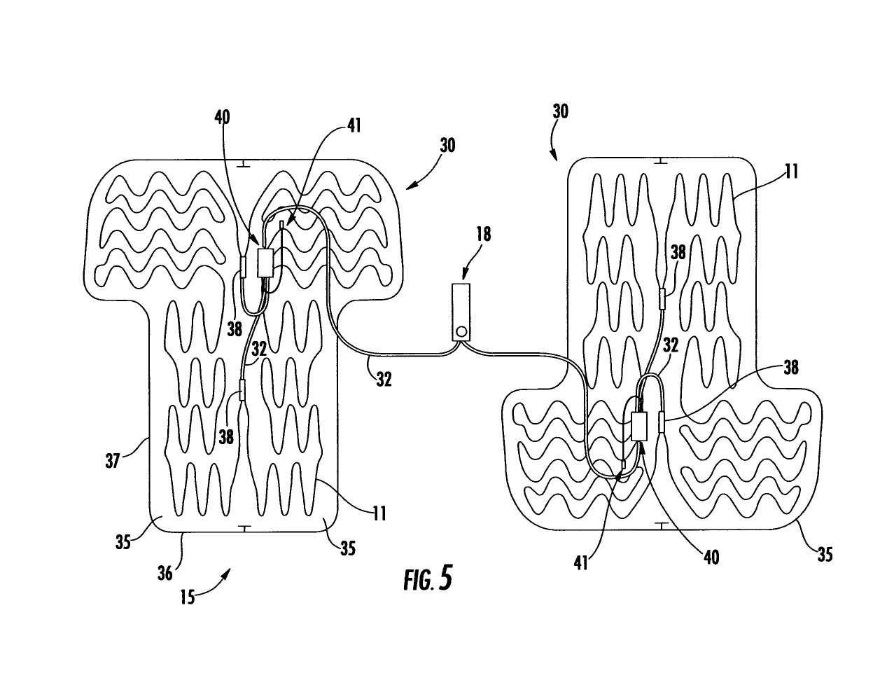

As illustrated in FIG. 4A-4B, the self-governing thermally regulated apparel item or garment 10 (here illustrated as a shirt) generally will include a garment body 20, with first and second or front and rear portions of panels 21-22. Sleeves 23 can be attached thereto and an upper or neck opening 24 and lower or waist opening 26 formed therealong. A heating assembly 15 can be applied to one or both of the first or front and second or rear portions 21/22 of the garment body 20. In the embodiment illustrated in FIGS. 4A-5, a pair of heating element assemblies 15 are utilized, with one located along the back portion 22 and one along the front portion 21 of the garment body. It will, however, also be understood by those skilled in the art that a single heating assembly can be used, or in some applications, more than 2 heating assemblies also can be used, for example, including additional heating element assemblies applied along sleeves or other portions of the garment.

As illustrated in FIG. 5, one embodiment, the integrated heating element assemblies 15 each can comprise a body 30 or unitary assembly formed as a substantially flat and flexible pad or similar member 30A that will be applied to or otherwise incorporated into the garment. For example, each heating element assembly 15 can be sewn, glued or otherwise attached along an inside surface of the front and/or back panels of the garment, can be inserted into a pocket or other enclosure formed in or attached to the garment, or can be placed between multiple plies or layers of the front and back panels of the garment and thus substantially fully integrated into the body of the garment with the attachment of these plies.

Additionally, as indicated in FIGS. 4A-4B, passages (shown at dash lines 31) further can be provided along or within the garment body adjacent the heating element assemblies for connecting the heating element assemblies to the apparel control unit. For example, open ended passages or channels 31 can be formed along the body of the garment, such as in instances where the heating element assemblies received within pockets or contained between multiple plies of the garment body, through which conductive wires, conduits or cables 32 can be run, such wires or cables will enable the transmission of electrical power and/or the communication of monitored electrical resistance or voltage measurement values between the apparel controller unit 18 and each of the heating element assemblies 15 of the garment. Alternatively, such conduits can be sewn, adhesively attached or can be clipped or otherwise applied/attached along an inner surface of the garment body. The cables or wires 32 also can include detachable connectors 33 at each end thereof for connection to the components of the heating element assemblies 15 to the apparel controller unit 18, which can be provided as a removable controller that is attachable/detachable from the garment or which can be a separate controller/system, and/or to a power source, as needed, to enable quick and easy replacement thereof.

The body 30 of each of the integrated heating element assemblies 15 can be formed in various configurations, for example, as additionally illustrated in FIGS. 4A-6C, being configured in a substantially “T” shaped configuration, and with the heating element assemblies applied to the front and back portions of the garment being substantially inverted to provide a desired coverage area to the garment. Other configurations or designs of the heating element assemblies also can be used.

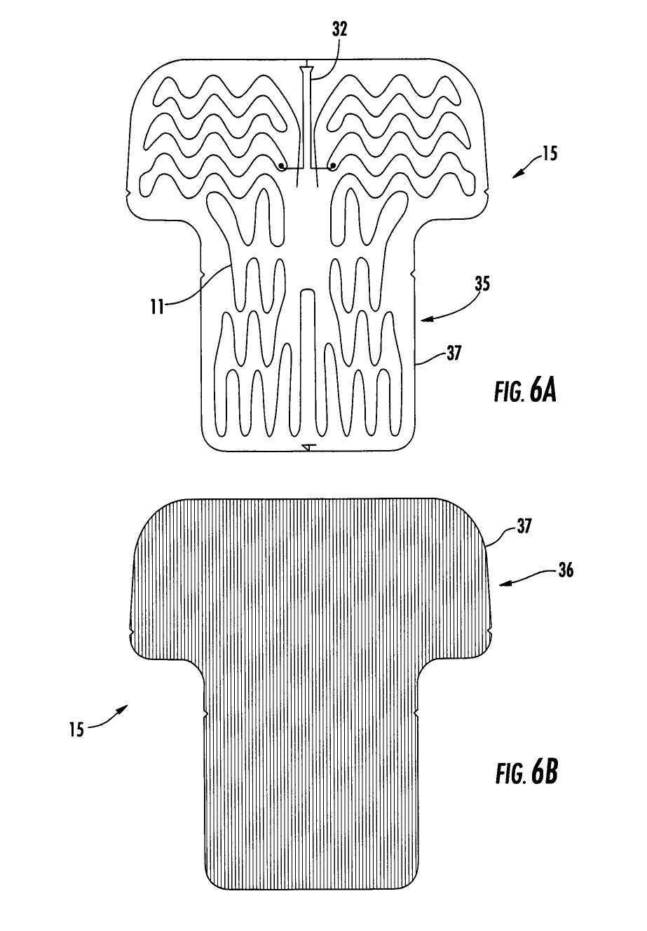

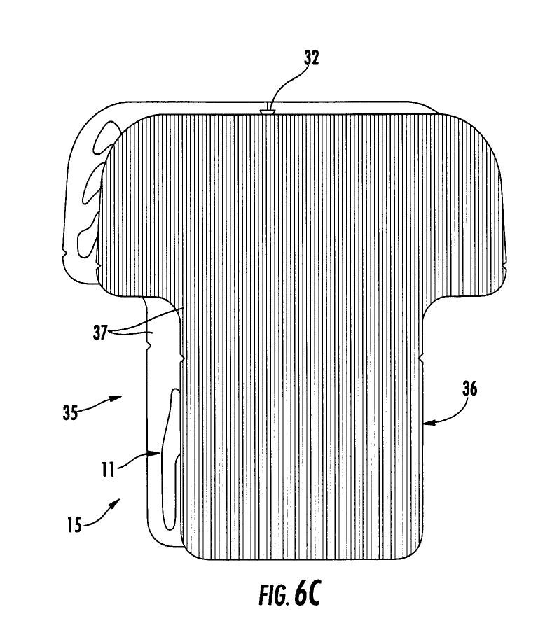

The body 30 of each integrated heating element assembly 15 further generally will include a base layer or substrate 35 (FIG. 6A) over which a top layer 36 (FIGS. 6B-6C) of a shielding fabric material, typically an electromagnetic or other electrical interference shielding material, will be applied/attached. The substrate and EMI shielding fabric layers generally will be attached together by stitching or other attachment means applied about the perimeter edges 37 thereof. The base layer or substrate 35 (FIGS. 6A and 6C) typically can include a flexible insulating fabric material, such as cotton or other, similar flexible fabric material that allows transmission of heat therethrough but will protect the wearer from direct contact with the electrically resistive heating element 11 of the heating element assembly. The EMI shielding fabric layer (FIGS. 6B-6C) typically can include a durable rip-stop type fabric, such as a silver threaded or lined rip-stop style fabric, including layers or integrated materials that are insensitive or resistant to electromagnetic and/or other types of electrical interference.

The heating elements 11 of each of the integrated heating element assemblies 15 further generally can comprise an electrically resistive heating element or wire formed from conductive filaments or thread formed from silver, steel or stainless steel, copper, nickel-chrome, gold, carbon fiber or other, similar conductive fibrous materials, can be applied in a desired pattern onto the substrate as shown in FIGS. 4A-6A. In one embodiment the electrically resistive heating element generally will be attached to the substrate by overlock stitching so as to attach or secure the electrically resistive heating element to the substrate and with the ends of the electrically resistive heating element generally being linked to an electric connector or coupling 38. The electrically resistive heating element typically will be applied in a substantially non-linear pattern, for example, in a generally zig-zag pattern as shown in FIGS. 4A-5, extending across and along a substrate, with the pattern being selected to enable maximum coverage or application of heat thereby. Other patterns also can be used. Alternatively, the electrically resistive heating element also can be attached via adhesive or other means or can be secured between the substrate and EMI shielding layer by the attachment or connection of the EMI shielding layer and substrate, such as by stitching applied along the peripheral edges 37 (FIG. 6C) thereof. As a result, a substantially integrated or unitary heating element assembly 15 including an electrically resistive heating element 11 that is flexibly supported by the substrate and which includes EMI protective shielding thereover is provided, which enables substantially self-governing thermal regulation or heating control while further protecting the user and the electronics and/or controller functionality of the system from electromagnetic interference.

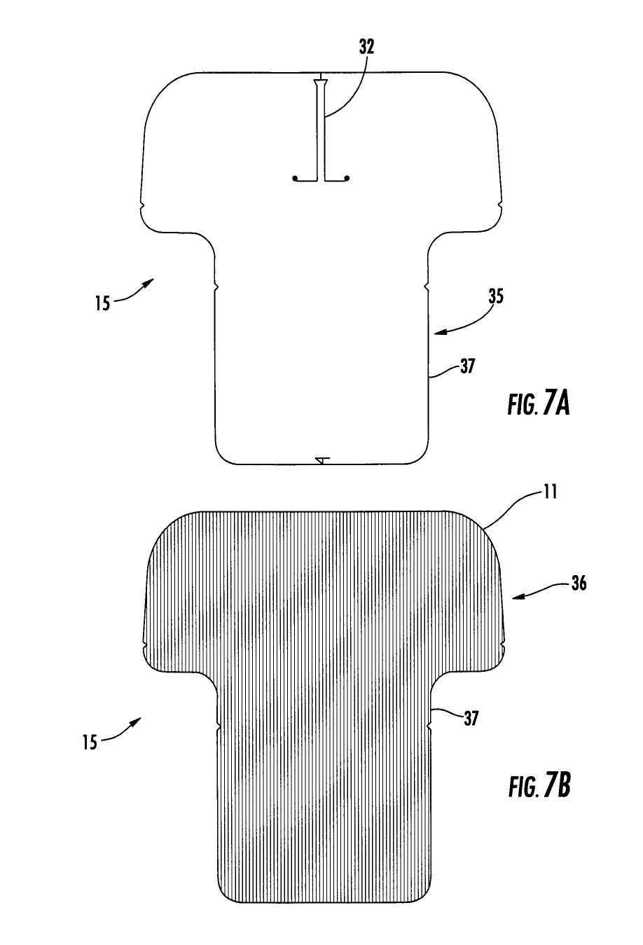

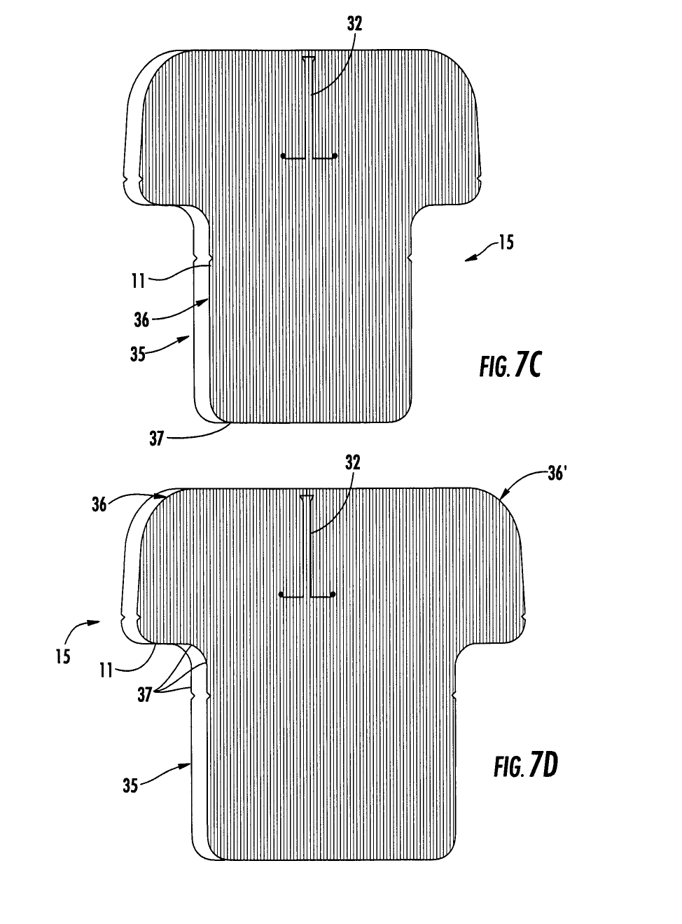

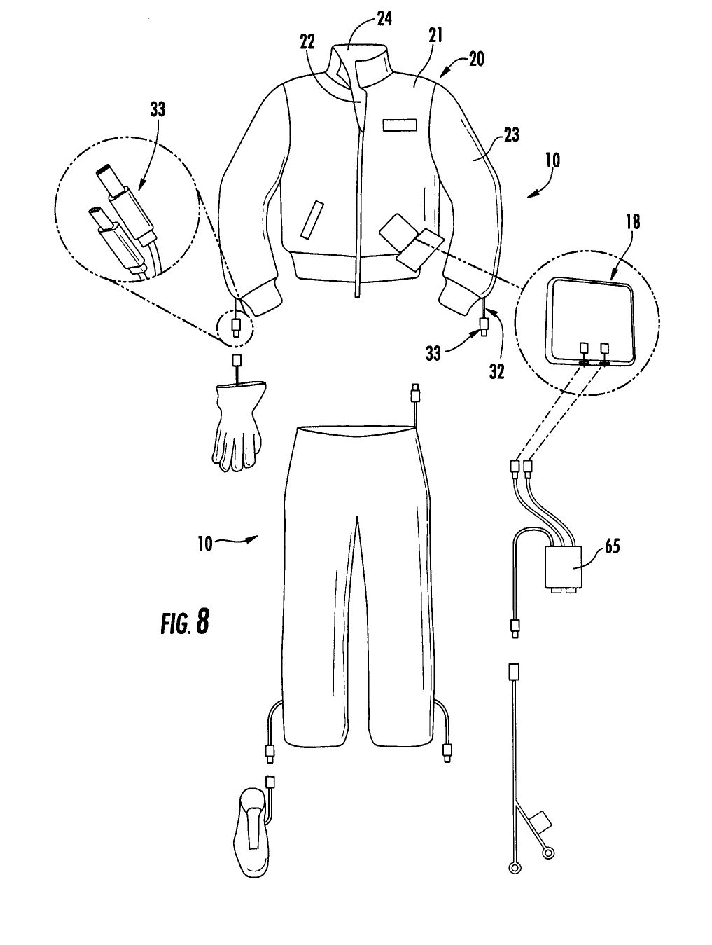

FIGS. 7A-7D illustrate further alternative embodiments of the self-governing thermally regulated apparel 10 with shielding protection. In the embodiment illustrated in FIGS. 7A-7D, the electrically resistive heating element 11 can be sewn or otherwise applied to or integrated directly into/with the EMI shielding fabric layer 36. Thereafter, the substrate layer 35 can be applied thereover and attached, such as by perimeter stitching 37, adhesive, or other means. As further shown in FIG. 7D, to the extent that additional EMI or other electrical interference shielding is necessary, depending upon the application or use of the self-regulated thermally regulated apparel item or garment, further layers of fabric shielding materials 36′ can be applied thereover.

In one embodiment shown in FIGS. 4A-5, each of the integrated heating assemblies 15 can further include an internal control module or processor 40 mounted between the substrate 35 and EMI shielding layer 36 (FIGS. 6A-6C). The control module 40 can function as an additional or back-up control to regulate application of heat by the heating assemblies, thus acting as a secondary control unit, and generally will be linked to both the electrically resistive heating element 11, such as by the ends of the wire or conductive filament thereof plugging into or otherwise being connected to the control module, as indicated in FIGS. 4A-5, and further generally will be linked to one or more thermistors 41, thermocouples, or other, similar electrical sensor devices mounted along the length of the electrically resistive heating element.

The control module 40 can receive and monitor electrical resistance provided by the one or more thermistors 41, or alternatively, can measure voltage levels across the electrically resistive heating element via thermocouples, and in turn will communicate this information to the apparel controller unit 18. The apparel controller unit can be integrated into or attached to the body of the garment, such as indicated in FIGS. 4A and 4B, and can be coupled to a power source 50 that can be integrated into the garment, into/with the controller unit itself, or can be a separate power source connected thereto by an input conduit or cable 51, as indicated in FIG. 4A. Typically, the apparel controller unit can be connected or attached along an area or portion of the garment body that will enable access and operation thereof, without interfering with the wearer's movement or performance of tasks, etc., while wearing the self-governing thermally regulated apparel item or garment. In one example embodiment illustrated in FIGS. 4A and 4B, the apparel controller unit 18 can be mounted along one side of the body of the garment adjacent an underarm or sleeve portion thereof. Other placements or locations also can be used.

The thermistors utilized in the self-governing thermally regulated apparel or heated garments of the present invention can include a variety of different types of thermistors, including substantially lower-cost thermistors, such as thermistors that can incorporate up to a 20% tolerance or margin with respect to electrical resistances measured thereby. In addition, the thermistors utilized do not have to be closely calibrated or selected for tight tolerances or correspondence with actual measured temperatures. Instead, the user or wearer can select or correlate a measured resistance value based on their own warmth/comfort level, so as to program or set the apparel controller unit to apply/adjust a power level at which a desired amount of heat or thermal output is applied by the garment based upon a theoretical heat transfer growth in view of the recorded electrical resistance value or a range of values corresponding to such a desired, user preferred or prescribed thermal output. Thereafter, the apparel controller unit 18 can receive monitored or measured electrical resistance values measured or detected by the one or more thermistors mounted within the heating assemblies via the control module of each heating assembly.

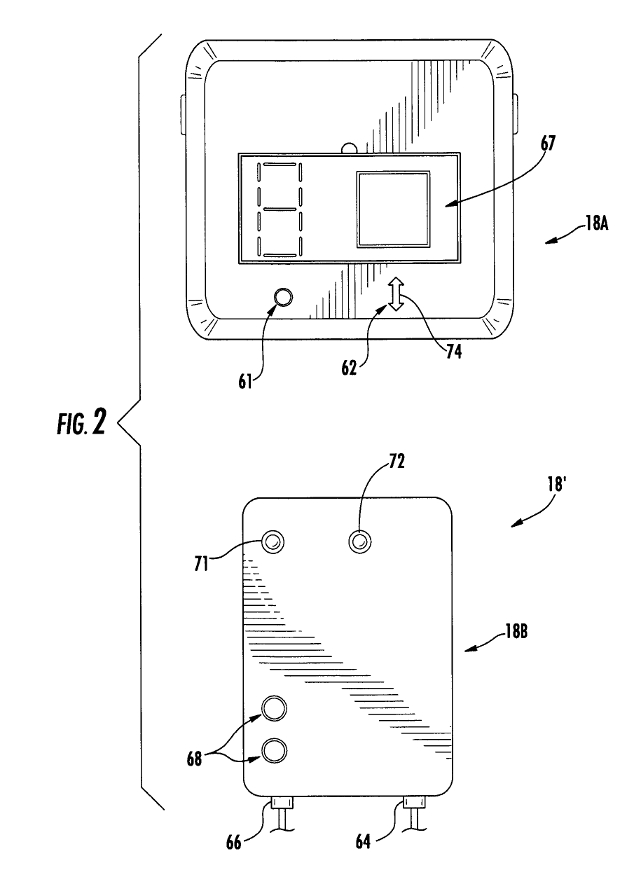

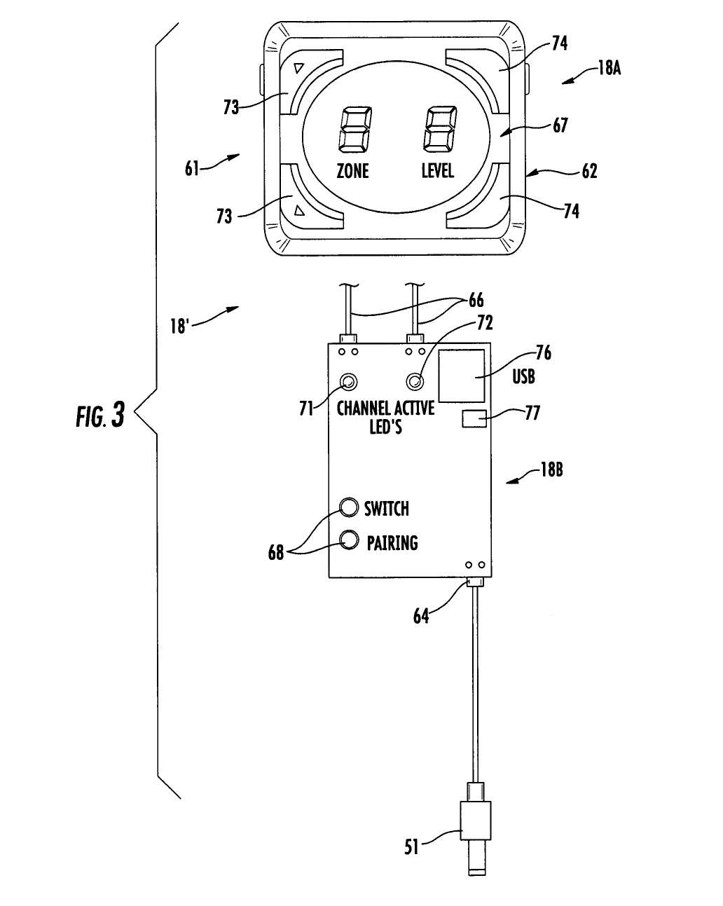

The control modules 40 of each heating assembly can be configured to record or detect such thermistor electrical resistance values at preset intervals and can communicate this information to the apparel controller unit, either substantially in real time as such measurements are being recorded, or at a further interval such as may be needed to conserve power of an internal power source or supply. Where multiple thermistor resistance measurements are provided, the apparel controller unit 18 can be configured to use such information, such as by averaging the received measured resistance values for the garment, or by display and/or control of the heating assemblies of the garment as separate zones, as indicated in FIG. 3. The apparel controller unit 18 further can be removable or can be provided as a separate unit that can be connected to each of a series of heating assemblies 15, as indicated in FIGS. 5 and 8, and further can connect to an external power source or other control. For example, the apparel controller unit 18 can be included as part of an environmental control system such as for an aircraft cargo bay or inside a vehicle to provide monitored feedback and control for a variety of different and/or interconnected garments, and can be configured to allow a user to control such interconnected garments separately, as indicated in FIG. 3. In further alternatives, as shown in FIGS. 2-3, the apparel controller unit 18 can include separable parts, including a first or wireless control part 18A, and a second, base or receiver part 188.

In some embodiments, the controller unit 18 can contain two or more channels, where each channel of the controller unit is capable of detecting and recording the electrical value of an associated or selected thermistor limited to the control module 40 or to a transmitter attached to an apparel item. The end user engages a particular channel on the controller unit once the desired thermal output is achieved for the particular apparatus apparel item associated with a particular channel on the controller unit. The controller unit then detects an electrical resistance value of a thermistor. This allows the controller unit to read and record electrical resistance values for a multitude of garments, each of which is associated with a particular channel on the controller unit. The controller unit is capable of applying varying power levels to keep the electrical resistance value within a predefined range for a multitude of garments, each of which is associated with a particular channel on the controller unit.

Other exemplary embodiments may include the self-governing apparel item wherein the power source is a battery or replaceable/rechargeable power supply integrated into and/or removable from the garment or the apparel controller unit itself. In other embodiments, the power source will be an external source capable of detachably connecting to the self-governing apparel through an auxiliary port. Varied power source possibilities create design and engineering flexibility, which enables the present inventive concept to be tailored to variety of fields of use or recreational activities.

Demonstrative embodiments may also include the use of a thermocouple wherein the controller unit records the voltage level of the thermocouple as the value of interest. In instances where economic considerations dominate, the apparel controller unit may incorporate thermocouples with an operating tolerance of approximately 1% up to approximately 20% or greater.

Referring to FIG. 1, one exemplary embodiment of the apparel controller unit 18 is shown. The apparel controller unit 18 shown in FIG. 1 includes two user/input controls 61/62, and a display 63, such as an LED, or similar indicator. A first user/input control 61 can comprise a user setting control and is configured to establish and transmit an electrical power output from an electrical power supply 64 to the heating assemblies controlled thereby via one or more electrical power outlet connectors 66. An additional connector 65 also can be provided for separately linking the apparel controller unit to another controller or autopilot control system as needed. The electrical power output can be continuously repeated at a predetermined amperage and also for a predetermined frequency and duration, depending on a setting input from the user. For example, at a desired heating level, the user can engage the first control to set the power level going forward.

The apparel controller unit 18 of FIG. 1 also includes a second input or user control 62. The second input or user control is capable of being engaged and disengaged by the user. It can be configured such that when it is initially engaged, an electrical resistance value of a thermistor is measured, or alternatively, a voltage level of a thermocouple is measured. Such measured values can be shown on the display 63 as the user varies the power output to the heating assembly, to provide the user with a visual indicator (i.e., a numerical value of 1-9 or other indication) of a desired thermal output level based on measured resistance/voltage levels. The user can then fix or set a desired level. While the resistance value and/or voltage level is measured, as long as the second control is engaged, the setting of the first control is overridden. The electrical power output can be substantially automatically varied by the apparel controller unit such that the measured electrical resistance value of the thermistor or the voltage level of the thermocouple remains relatively constant with respect to the initially measured and set/predetermined values. In other words, the resistance value and/or voltage level is maintained within a predetermined range with respect to the initially measured values. When the second control is disengaged, the electrical power output returns to the last electrical power output setting established by the first control.

Referring to FIG. 2, another exemplary controller 18′ with two sections or parts 18A/18B is shown. According to FIG. 2, the apparel controller unit 18 includes a transmitter section 18A and a base or receiver section 18B, although each part is capable of both transmitting and receiving wireless signals. The first part of the apparel controller unit, the wireless transmitter 18A can include the first input or user setting control 61, and also an auto pilot user control or a second input or user control 62. The base or receiver part 18B of the controller unit 18, generally will include electrical input and output connections 64/66 from the power supply 62 as well as a display 67, such as an LED or LCD screen and to the power output connector and also can include a connection/pairing status indicator 68.

Referring to FIG. 3, another exemplary apparel controller unit 18 with two parts 18A/18B and two independent operating channels 71/72 is shown. The wireless transmitter part 18A can include two independent user setting controls, including the first user or input control, and an auto pilot control or second user or input control. In this embodiment, the first user or input control can include 2 or more buttons or switches 73 for enabling the user to switch between the 2 or more operating channels so as to enable control of multiple heating zones, for example multiple different parts, areas or locations of a heated garment, or for control of multiple linked garments, as shown in FIG. 8. The second user control likewise can comprise 2 or more buttons or switches 74 (FIG. 3) or a single toggle switch 76 (as shown in FIG. 2) or similar switch mechanism, to enable user adjustment of the thermal output of the heating elements for each garment or zone. The receiver includes one connection to the power supply. The receiver also can include two or more independently controlled power output connectors 66.

Referring to FIG. 8, examples of various thermal-regulated apparel items are shown. These examples include a jacket, glove, pants, and shoe insole. Each may be connected to each other or directly to the controller.

In some embodiments, the controller includes two or more electrical power outlet connectors. In some embodiments, the controller includes two or more first controls, each operating independently from the other. In some embodiments, the controller includes two or more second controls, each operating independently from the other. In some embodiments, the controller includes two or more electrical power outlet connectors, each operating independently from the other. In some embodiments, the controller includes two separable parts in wireless communication with each other, sometimes referred to as a transmitter and a receiver, although both components are capable of both transmitting and receiving wireless signals, and each including its own power supply or connection/power inlet connectors.

In some embodiments, such as shown in FIG. 4A, the power source 50 for the power controller unit and heating element assemblies can be incorporated into or detachably connected to the thermal-regulated apparel item independent of the use of the electrical connections of the apparel controller unit. For example, the power source 50 can be a battery or similar replaceable and/or rechargeable power pack that fits into the garment or connects to or is part of the apparel controller unit or can include a connection to an electrical generator. In embodiments where the apparel controller unit includes a wireless transmitter part/section 18A (FIGS. 2-3), this section or part 18A can be provided with an internal power source, such as replaceable and/or rechargeable batteries, so as to be rechargeable by replacement of the batteries therein or by mounting the part on a cradle of dock, and/or can also include auxiliary power/data port connections. Additionally, where multiple power outlet connectors are provided by the article controller unit, one connector can be attached to one apparel item and another connector can be connected to a second apparel item to separately power/heat each apparel item, and with each different apparel item being regulated independently from the other. In some embodiments, the thermistor or thermocouple is embedded within the thermal-regulated apparel item.

Additional objects of the general inventive concept include providing a method of heating and control of heat applied to an electrically-powered thermal-regulated apparel item. The method includes establishing an electrical power output from an electrical power source to an electrical power outlet connector in the controller as described above. In some embodiments, the method includes measuring the electrical resistance value of a thermistor or measuring a voltage level of a thermocouple and varying the electrical power output such that the resistance value or voltage level remains relatively constant with respect to the initially measured value/voltage level.

The exemplary embodiments of the present general inventive concept are implemented as a method of thermal regulation, an apparatus capable of thermal regulation, and a system capable of thermal regulation. While the present general inventive concept has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use; applications in contexts beyond thermal regulation of apparel also exist.

It is also to be understood that the claims to follow are or will be intended to cover all of the generic and specific features of the invention herein described, and all statements of the scope of the invention which, as a matter of language, might be said to fall therebetween. Hence, the proper scope of the present general inventive concept should be determined only by the broadest interpretation of such claims so as to encompass all such modifications as well as all relationships equivalent to those illustrated in the drawings and described in the specification.

Finally, it will be appreciated that the purpose of the annexed Abstract is to enable the

U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. A thermally regulated garment, comprising:
a garment body including first and second body portions;
an integrated heating element assembly applied to at least one of the first and second body portions of the garment and comprising a substrate, and at least one layer of an electromagnetic interference shielding material substantially covering and attached to the substrate with an electrical heating element extending in a desired pattern located therebetween;
a controller coupled to the heating element assembly, the controller having an electrical power connection for receiving and transmitting electrical power from a power supply to the heating element assembly, and configured to control transmission of electrical power to the heating element assembly sufficient to maintain an electrical resistance value or a voltage level measured along the heating element substantially at a predetermined value or within a predetermined range for the electrical resistance or voltage level.

2. The thermally regulated garment of claim 1, wherein the electrical resistance heating element comprises a conductive wire, filament, fiber or thread.

3. The thermally regulated garment of claim 2, wherein the heating element is selected from the group comprising silver, steel, copper, nickel-chrome, gold or carbon materials.

4. The thermally regulated garment of claim 1, wherein the electrical heating element is applied to the substrate in a substantially zig-zag pattern.

5. The thermally regulated garment of claim 1, wherein the layer of shielding material is attached to the substrate by stitching substantially applied along perimeter edged thereof.

6. The thermally regulated garment of claim 1, further comprising at least 2 layers of electromagnetic interference shielding material applied to the substrate.

7. The thermally regulated garment of claim 1, wherein the layer of shielding material comprises a rip-stop fabric material, and wherein the electrical resistance heating element is attached to the layer of shielding material by stitching.

8. The thermally regulated garment of claim 1, wherein the integrated heating element assembly includes at least one thermistor or at least one thermocouple located along the heating element and configured to measure the electrical resistance value of the voltage level along the heating element, and;
wherein the controller comprises:
a first input control configured to establish an electrical power output from an electrical power source to an electrical power outlet connector; and
a second input control, capable of being engaged and disengaged by the user, configured such that when engaged, the electrical resistance value of the thermistor or the voltage level of the thermocouple is measured and the electrical power output is varied by the controller such that the measured electrical resistance value of the thermistor or voltage level of the thermocouple substantially remains within the predetermined range for the measured electrical resistance value of the thermistor or the measured voltage level of the thermocouple.

9. The thermally regulated garment of claim 1, wherein said controller comprises two or more electrical power outlet connectors.

10. The thermally regulated garment of claim 8, wherein two or more first input controls, each operating independently from the other first input controls, wherein said electrical power output at each of said two or more electrical power outlet connectors is independently controlled by one of said two or more first input controls.

11. The thermally regulated garment of claim 1, further comprising a power source attached to the garment body and connected to the controller.
